(19) United States
(12) Patent Application Publication
(10) Pub. No.: US 2025/0042175 A1
(43) Pub. Date: Feb. 6, 2025

(54) METHOD FOR DIGITAL PRINTING ON A SHEET

(71) Applicant: SYSTEM CERAMICS S.P.A., FIORANO MODENESE (IT)

(72) Inventors: ANDREA ANNOVI, CORLO DI FORMIGINE (IT); GIULIANO PISTONI, BAISO (IT); FEDERICO CAVALLINI, MODENA (IT)

(21) Appl. No.: 18/717,470

(22) PCT Filed: Jan. 13, 2023
(86) PCT No.: PCT/IB2023/050307

§ 371 Date: Jun. 7, 2024

(30) Foreign Application Priority Data
Jan. 17, 2022 (IT) 102022000000593

(51) Int. Cl. B41J 2/21; B41M 5/00

(52) U.S. Cl. CPC B41J 2/2132; B41M 5/0047; B41M 5/007; B41M 5/0088

(57) ABSTRACT

A machine and a method for digital printing on a sheet having an edge, including the following steps: providing a main reference system; providing an image having a contour, positioned in a pre-established manner relative to said main reference system; translating the sheet in advancement along an advancement direction on an advancement plane; during the advancement of the sheet; performing a succession of scans of consecutive zones of the sheet; in each zone, defining a plurality of nodal points relative to said main reference system; associating with each nodal point a corresponding image point of the image, by means of a pre-established calculation method; processing a modified portion of the image, moving each image point, and a portion of the contour adjacent to that image point, in a pre-established position respect to the relative nodal point; printing the modified portion on the sheet.

The present invention relates to a method and a machine for digital printing on glass, ceramic or other material.

The invention is particularly advantageous for printing darkened edges on glass sheets intended to be applied to motor vehicles.

In general, the invention allows to digitally print a decoration on a shaped sheet, with very high positioning precision relative to the edges of the sheet itself.

In particular, some examples of glass sheets refer to windows or windscreens for motor vehicles which normally have irregular profiles or shapes and cannot be traced back to particular geometric shapes.

For example, the glass sheets for motor vehicles are decorated by affixing logos and/or various writings, as well as affixing dark and opaque bands along the edge zones, to protect the adhesives from ultraviolet radiation.

Other examples of glass media relate to decorative glass or glass for hobs or glass in general.

Nowadays, for industrial productions, decorations are printed by means of the use of digital ink jet printers, which work with the “single pass” method on the objects to be printed, or while the objects advance on a transport surface, without the need to stop the advancement thereof.

To be able to accurately print digitally, it is necessary to precisely locate the objects to be printed with respect to a reference system known to the printer. Some methods are currently available which include detecting the position of the object to be printed on the transport surface, in a position situated upstream relative to the digital printer. The data related to the position of the object are transmitted to the printer which, by means of a special adaptation algorithm, modifies the image to be printed, deforming it and/or moving it as a function of the data related to the position of the object.

In the currently available methods, the acquisition and recognition of the position of the object to be printed occurs at a certain distance from the digital printer. The position of a frontal zone or of the entire object is acquired and the relative data are transmitted to the printer, for the adaptation of the image to be printed. That is, the correction or adaptation affects the entire graphic to be printed.

In the case of very elongated objects, for example glass of large dimensions, it may happen that, during transport, the final part of the glass undergoes involuntary movements, or a small angle error on the initial reading of the position of the glass can cause a positioning angle error on the end of the glass. This results in an incorrect alignment of the graphic on the object. In practice, only the initial part of the print is correct and centred relative to the geometry of the object, while the portion of the print which is executed towards the end is increasingly less aligned.

Examples of currently available methods, which do not solve the technical problem summarised above, are described in documents WO 2020/079624 and JP 2019 064176.

The object of the present invention is that of solving the technical problems summarised above.

The main advantage of the present invention is that it allows to obtain a print which is perfectly centred and adapted to the geometry of the object to be printed.

Additional features and advantages of the present invention will become more apparent from the detailed description that follows of an embodiment of the invention in question, illustrated by way of non-limiting example in the appended figures, in which:

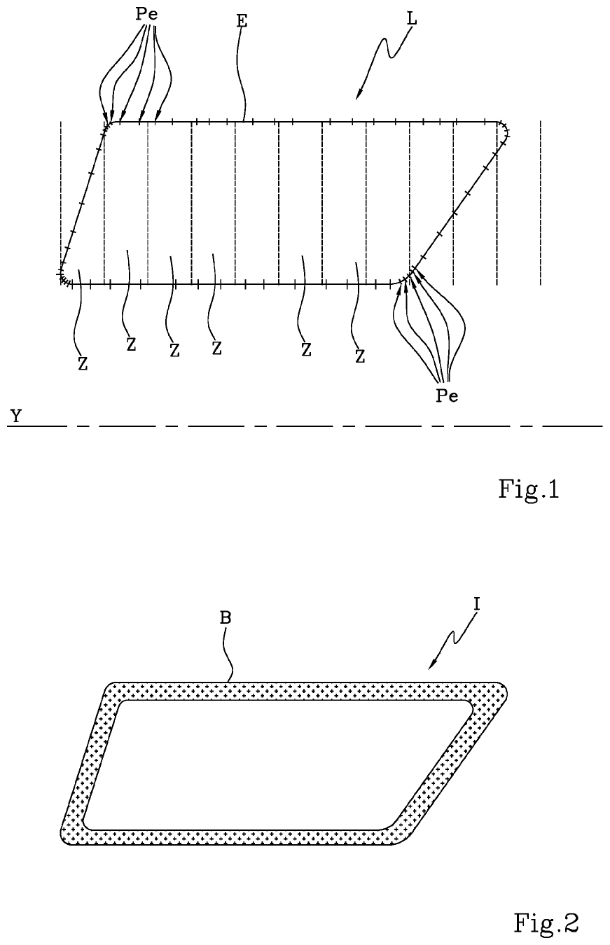

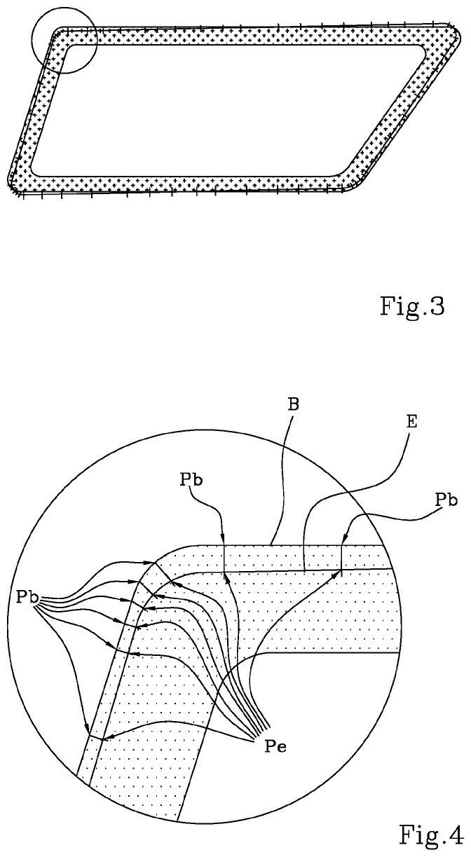

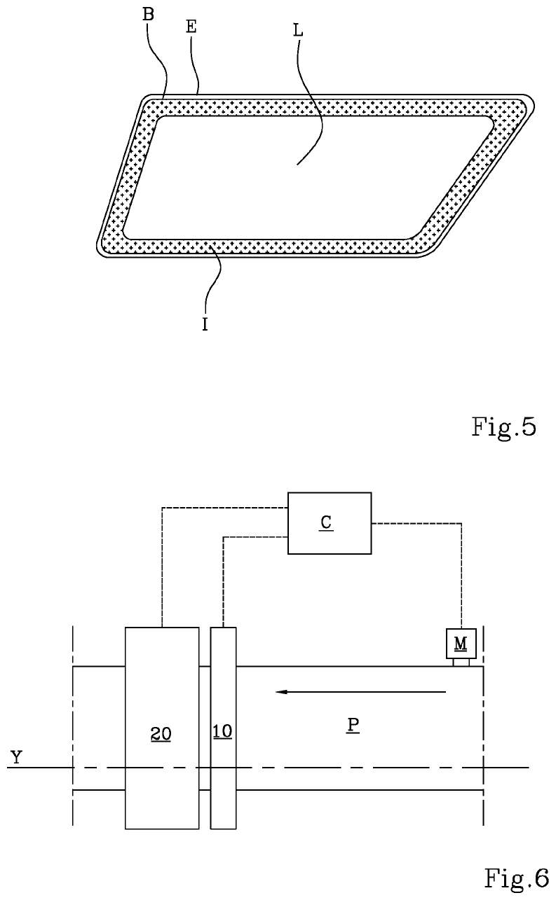

FIGS. 1 to 5 schematically show the steps of the method according to the present invention;

FIG. 6 shows a schematic plan view of a machine arranged to implement the method according to the present invention.

In the following description, reference will be made to a sheet (L) provided with an edge (E). The sheet (L) can be of ceramic material, glass or other material.

The following description will also refer to the digital printing of an image (I). Digital printing is intended as printing performed by means of an ink jet digital printer. As is known in the art, an ink jet printer comprises a plurality of emission nozzles of printing liquid, ink, enamel, or other. Each nozzle is digitally controllable to determine the emission or non-emission of the printing liquid.

The various nozzles are associated with printing heads and are facing downwards, to deliver the printing fluid towards an underlying transport surface of the objects to be printed. The printing occurs with the so-called “single pass” method, i.e., it occurs while the objects are in motion on the transport surface.

The nozzles, associated with the various heads, are grouped in printing bars, i.e., in groups of nozzles arranged so as to define a printing front in the form of a band oriented transversally with respect to the advancement direction of the objects to be printed. The printing front is substantially the area covered by the fluid delivered by the nozzles, i.e., the surface which is hit by the fluid delivered by the nozzles belonging to the printing bar.

The method according to the present invention includes providing a main reference system. Such a main reference system is used to define the position of both the printing bars, the sheet (L) and the image (I) to be printed on the sheet (L). The image (I) is essentially a graphic file depicted in a colour space, for example RGB, CMYK or any other known colour space

The method according to the present invention further includes providing an image (I) to be printed on the sheet (L), and positioning the image (I) in a given position relative to the main reference system. In essence, the image (I) is positioned in a pre-established manner with respect to the main reference system.

The method includes translating the sheet (L) in advancement along an advancement direction (Y) on an advancement plane (P). The sheet (L) advances with a pre-established speed, which can be set according to the production needs.

During the advancement of the sheet (L), i.e., without stopping the sheet (L), the method includes carrying out the following steps.

The method includes performing a succession of scans of consecutive zones (Z) of the sheet (L). That is, as the sheet (L) advances, the method includes scanning the sheet (L) by consecutive zones, so as to acquire significant data for each of the scanned zones (Z).

For example, the scanning of the zones (Z) is performed by an optical means (10), arranged to acquire an image of each zone (Z). Such optical means will be better described in the following description.

For each zone (Z), the method includes defining at least one nodal point (Pe) of the sheet. The nodal point (Pe) can be located in any position of the sheet (L) in the scanned zone (Z). For example, the nodal point (Pe) is located on the edge (E) of the sheet (L). The nodal point(s) (Pe) is/are defined relative to the pre-established reference system. In particular, the nodal point(s) (Pe) is/are defined in terms of coordinates relative to the provided reference system.

For example, the nodal points (Pe) of the edge (E) of the sheet (L) are defined by approximating the edge (E) with a polygonal line, according to a pre-established approximation formula. The nodal points (Pe) are the vertices of said polygonal line. Various methods and approximation formulas are known to those skilled in the art, who will be able to choose the most suitable one relative to the shape of the sheet (L) and/or of the image (I). An example of a method suitable for the purpose is described in publication WO2020079624.

The nodal points (Pe) are defined relative to the main reference system. Since the position of the image (I) relative to the main reference system is known, for each nodal point (Pe) it is possible to define a position relative to any point of the image (I).

The method includes defining, for each nodal point (Pe), a corresponding image point (Pb) of the image. That is, the method includes associating a corresponding image point (Pb) with each nodal point (Pe).

In the case in which a nodal point (Pe) is located on the edge (E) of the sheet (L), the corresponding image point (Pb) is located on the contour (B) of the image.

The association between each nodal point (Pe) and a respective image point (Pb) can be defined by various mathematical or calculation methods known in the field. For example, in a preferred but not exclusive embodiment, each image point (Pb) is defined as an intersection between the contour (B) of the image (I) and the perpendicular to the edge (E) passing through the nodal point (Pe).

For each image point (Pb), the method includes processing a modified portion (Im) of the image (I), obtained by moving the image point (Pb), and a portion of the contour (B) adjacent to that image point (Pb), to a pre-established position relative to the relative nodal point (Pe).

In particular, the method includes processing the position data of each image point (Pb) to define a modified contour of the image (I) in a vicinity of the point (Pb) itself. Such a modified contour, which comprises the section of the edge (B) adjacent to the image point (Pb), defines the modified portion (Im) of the image (I), around the image point (Pb).

That is, each modified portion (Im) is obtained by adapting the image (I) to the modified contour around the defined image points (Pb).

Each modified portion (Im) is thus printed on the sheet (L). In particular, each modified portion (Im) is intended to be subsequently printed on the sheet (L) in an optimal position to minimise the distance of the nodal points (Pe) corresponding to the image points (Pb) used to process the modified portion (Im) itself.

Advantageously, the method according to the invention does not require a complete scanning of the sheet (L) and obtaining an overall modified image, to be transmitted subsequently to the printer.

Rather, the method according to the present invention allows to process the image (I) by consecutive areas, defined as a function of the image points (Pb), so as to obtain a succession of modified portions (Im) of the image (I), each of which is intended to be printed in a pre-established position on the sheet (L). In practice, each modified portion (Im), as soon as available, can be transmitted to the digital printer (20), so that the digital printer (20) is capable of printing it on the sheet (L) in the pre-established position, as soon as the sheet (L) is in the intended position with respect to the printing nozzles.

This allows to acquire the position data of each nodal point (Pe) in the vicinity of the digital printer (20), so that the corresponding modified portion (Im) of the image (I) can be processed and printed as a function of the actual position and shape of the sheet (L), making the position error of the modified portions (Im) minimal or zero due to any undesired movements undergone by the sheet (L) downstream of the acquisition station (10). The concatenation of the modified portions (Im) forms a modified image which is printed on the sheet (L). Furthermore, the method according to the present invention allows to limit or cancel the positioning errors of the image (I) on the sheet (L) due to dimensional deviations of the sheet (L) relative to the expected dimensions. Such deviations are frequently due to the consumption of the grinding wheels used for contouring the sheet (L).

The modified portions (Im) are printed in succession on the sheet (L). Advantageously, each modified portion (Im) of the image (I) is printed on the sheet (L) during the processing of one or more successive modified portions (Im) of the image (I). As already underlined, the possibility of processing each modified portion (Im) independently of the others, allows to print each modified portion (Im) while other subsequent modified portions (Im) are being processed. It is thereby possible to perform the scanning of the sheet (L) at a very limited distance from the printer (20).

As already specified, the method includes processing, for each image point (Pb), a modified portion (Im) of the image (I), obtained by moving the image point (Pb), and a portion of the contour (B) adjacent to that image point (Pb), to a pre-established position relative to the relative nodal point (Pe). In a preferred embodiment of the method, said section adjacent to an image point (Pb) is the section of the contour (B) comprised between the image point (Pb) and a subsequent image point (Pb). In practice, the method includes moving, together with each image point (Pb), the previous and/or subsequent image point (Pb) and the contour section (B) comprised between the two image points (Pb), this for each pair of consecutive image points (Pb).

In a preferred embodiment of the method, the position data of the nodal points (Pe) are obtained from the processing of the image acquired at an acquisition station (10), located in a static position along the advancement direction of the sheet (L). Such an acquisition station (10) comprises an optical means (10) located in a pre-established position relative to the advancement plane (P). In a known manner, the optical means (10) comprises one or more linear or matrix cameras.

Preferably, the optical means (10) is located above the advancement plane (P), so as to be able to acquire the position data of the nodal points (Pe) for successive scans of zones (Z) of the sheet (L). An example of method for acquiring the position data of the nodal points (Pe) is described in patent application No. 102020000018793.

In particular, the acquisition station (10) is configured to scan consecutive zones (Z) of the moving sheet (L). The acquisition frequency of the zones (Z) is defined as a function of the advancement rate of the sheet (L) and/or the printing frequency of the image (I), in a manner known in the field.

One or more nodal points (Pe) are defined within each scanned zone (Z). For each point (Pe), the corresponding image point (Pb) is defined. Subsequently, each image point (Pb) is moved to a pre-established position relative to the corresponding nodal point (Pe), including the edge (B) around the image point (Pb), in the manners already described.

In a particularly effective embodiment of the method, to adapt the image (I) to the actual contour of the sheet (L) and obtain the modified portions (Im), each image point (Pb) is moved and positioned at a pre-established distance from the respective nodal point (Pe), towards the interior of the sheet (L). That is, the image points (Pb) are positioned at a pre-established distance from the edge (E) of the sheet (L), so that the contour (B) of the image (I) is overall separated by a pre-established distance from the edge (E) of the sheet. Thereby, the printing of the modified portions (Im) and, consequently, the overall printing of the image, leaves a portion of the sheet close to the edge (E) free. This ensures that the printing does not reach the edges of the sheet (L), since in many cases the edges of the sheet (L) must remain absolutely clean.

The printing of the modified image (Im) is obtained by a digital printer (20) known in the field. The optical means (10) is located upstream of the digital printer (20) relative to the advancement direction of the sheet (L).

The digital printer operates under the control of a command module, not shown, provided with a computer. The command module is connected, in addition to the digital printer (20), to the acquisition station (10) and to the motor system of the advancement plane (P). From the latter, the command module obtains information related to the position of each sheet (L), for example by means of an encoder. The control module has one or more images (I) in memory, each intended to be printed on a pre-established sheet (L). Depending on the data detected by the acquisition station (10), the command module selects and adapts the image (I) in the manners described above.

In particular, for each sheet (L), the acquisition station (10) sends the position data of the nodal points (Pe) to the command module. The command module is arranged to receive and process said position data of the nodal points (Pe), to define the corresponding image points (Pb) and, through the displacement of the image points (Pb), to obtain the modified portions (Im) of the image (I), so that the latter is adapted to the actual position and the actual shape of the sheet (L).

The command module is further arranged to transmit each modified portion (Im) to the digital printer (20), and to activate the digital printer (20) to print each modified portion (Im) when the sheet (L), through the advancement plane (P), reaches the correct position to receive the print of the modified portion (Im).

The method and the machine for the digital printing of sheets according to the present invention allows to greatly increase the dimensional precision, positioning and centring of the image relative to the sheet. This is because the present invention includes processing the image (I) by consecutive zones (Z) of the sheet (L), so as to obtain modified portions (Im) of the image (I), each of which is intended to be printed on the respective zone (Z). Thereby, each modified portion (Im), as soon as available, can be transmitted to the digital printer (20), so that the digital printer (20) is capable of printing it on the respective zone (Z) as soon as the latter is in the correct position relative to the printing nozzles, regardless of the analysis and processing of the subsequent zones (Z) of the sheet (L). This allows to perform the acquisition of the position data of each zone (Z) in a zone relatively close to the digital printer (20), making the position error of the modified portions (Im) minimal or zero due to any undesired movements undergone by the sheet (L) downstream of the acquisition station (10).

That is, each modified portion (Im) of the image (I) is processed substantially in real time taking into account the actual position and shape of the respective zone (Z). The modified image (Im), as a whole, is thus printed on the sheet (L) with significantly lower errors relative to those obtainable with the current printing methods.

1) A method for digital printing on a sheet (L) having an edge (E), comprising the following steps:
providing a main reference system;
providing an image (I) having a contour (B), positioned in a pre-established manner relative to said main reference system;
translating the sheet (L) in advancement along an advancement direction (Y) on an advancement plane (P);
during the advancement of the sheet:
performing a succession of scans of consecutive zones (Z) of the sheet (L);
in each zone (Z), defining a plurality of nodal points (Pe) relative to said main reference system;
associating with each nodal point (Pe) a corresponding image point (Pb) of the image, by means of a pre-established calculation method;
processing a modified portion (Im) of the image (I), moving each image point (Pb), and a portion of the contour (B) adjacent to that image point (Pb), in a pre-established position respect to the relative nodal point (Pe);
printing the modified portion (Im) on the sheet (L).

2) The method according to claim 1, wherein at least some of the nodal points (Pe) of the plurality of nodal points are points of the edge (E) of the sheet (L), and wherein the respective image points (Pb) are points of the contour (B) of the image (I).

3) The method according to claim 2, wherein each image point (Pb) is defined as an intersection between the contour (B) of the image (I) and the perpendicular to the edge (E) passing through the nodal point (Pe).

4) The method according to claim 1, wherein the modified portions (Im) are printed in succession on the sheet (L).

5) The method according to claim 1, wherein each modified portion (Im) of the image (I) is printed on the sheet (L) during processing of one or more successive modified portions (Im) of the image (I).

6) The method according to claim 1, wherein said portion of the contour (B) adjacent to an image point (Pb) is the portion of the contour (B) comprised between the image point (Pb) and a subsequent image point (Pb).

7) The method according to claim 1, wherein the nodal points (Pe) of the edge (E) of the sheet (L) are defined by approximating the edge (E) with a polygonal line according to a pre-established approximation formula, and wherein the nodal points (Pe) are vertices of said polygonal line.

8) A machine for digital printing on a shaped sheet, comprising:
an advancement plane (P), movable in advancement along a longitudinal direction (Y) by means of digitally controlled motor means;
an acquisition station (10), configured to acquire a succession of images of the sheet (L) in advancement on the advancement plane (P);
a digital printer (20), located downstream of the acquisition station (10);
characterised in that it comprises a command module connected to the motor means of the advancement plane (P), to the acquisition station (10) and to the digital printer (2), and which is configured to implement the method according to claim 1.
